(19) United States
(12) Patent Application Publication
(10) Pub. No.: US 2014/0325991 A1
(43) Pub. Date: Nov. 6, 2014

(54) Aircraft having an Engine, a Fuel Tank, and a Fuel Cell

(71) Applicant: EADS Deutschland GmbH, Ottobrunn (DE)

(72) Inventors: Kan-Ern Liew, Antwerp (BE); Juergen Steinwandel, Uhldingen-Muehlhofen (DE)

(73) Assignee: EADS Deutschland GmbH, Ottobrunn (DE)

(21) Appl. No.: 14/365,293

(22) PCT Filed: Dec. 3, 2012
(86) PCT No.: PCT/DE2012/001146

§ 371 Date: Jun. 13, 2014

(30) Foreign Application Priority Data
Dec. 16, 2011 (DE) 10 2011 121 176.8

(51) Int. Cl. F02C 9/18

(52) U.S. Cl. CPC F02C 9/18
USPC 60/785

(57) ABSTRACT

An aircraft includes a propulsion unit with a compressor and a bleed air device for providing bleed air from the propulsion unit, a fuel tank for a fuel, at least one fuel cell, a reactor for reforming fuel from the fuel tank to a hydrogen-containing fuel gas, and at least one feed unit with a bleed air inlet, a fuel inlet, an oxidizing agent outlet, and a fuel outlet. The feed unit can selectively and not simultaneously feed an oxidizing agent by means of the oxidizing agent outlet or fuel by means of the fuel outlet into the reactor. The feed unit is connected to the bleed air device and designed to provide the oxidizing agent based on bleed air.

### TECHNICAL FIELD

Exemplary embodiments of the present invention relate to an aircraft having a propulsion unit with a compressor and a bleed air device, a fuel tank, and at least one fuel cell.

### BACKGROUND OF THE INVENTION

Fuel cell systems make it possible to produce electric current with low emission and a high level of efficiency. Therefore, there are currently also efforts in aircraft construction to use fuel cell systems for producing the electric energy needed on-board of an airplane. For example, it is conceivable to replace, at least to some extent, the generators currently powered by main propulsion units or an auxiliary power unit for producing on-board current by a fuel cell system. Furthermore, fuel cell systems can also be used for the emergency power supply of the airplane.

Typically, fuel cells comprise a cathode region and an anode region separated from the cathode regions by an electrolyte. During operation with fuel cells with a proton exchange membrane, also known as polymer electrolyte membrane (PEM), a reducing agent, usually hydrogen, is fed to the anode of the fuel cell, and an oxidizing agent, for example air, is fed to the cathode of the fuel cell. At the anode, the hydrogen is catalytically oxidized to hydrogen ions while releasing electrons. By means of the electrolyte, the ions reach the cathode region where they react to water with the oxygen fed to the cathode and the electrons transmitted to the cathode by means of an external circuit. PEM fuel cells have operating temperatures of up to 100° C. In solid oxide fuel cells (SOFC), an electrolyte from a solid ceramic material is used, which is capable of transmitting negatively charged oxygen ions from the cathode to the anode, but which has an insulating effect on electrons. The oxygen ions thus oxidize electrochemically with hydrogen or carbon monoxide on the anode side. The operating temperature of solid oxide fuel cells is in a range between 500° C. and 1000° C.

Hydrogen used for operating a fuel cell on board the aircraft is obtained either directly from a tank or indirectly produced catalytically from a fuel in a reactor, also called reformer. The fuel used in aircrafts for producing hydrogen in the reforming process is kerosene. Kerosenes are aviation fuels of different specifications that are predominantly used as aviation turbine fuels. Kerosene is removed from the top column plates of the medium distillate of petroleum rectification. The main components of kerosene are alkanes, cycloalkanes, and aromatic hydrocarbons with approximately 8 to 17 carbon atoms per molecule. In civil aviation, kerosene with the specification Jet A-1 is almost exclusively used as aviation turbine fuel. Although kerosene is a narrow fractionating cut from the light medium distillate of petroleum refining, it still consists of a mixture of numerous hydrocarbons, wherein the number of compounds contained in the mixture is increased further due to the addition of functional additives in order to meet the respective specifications.

During the catalytic production of hydrogen from kerosene, it is possible for coke to accumulate on the surface of a catalyst in the reformer due to incomplete chemical conversion. During this process, also called coking or poisoning, the active surface of the reformer catalyst is diminished, which results in a shorter service life of the reformer.

The operating temperature of PEM fuel cells is limited to 100° C. due to a water content in the membrane required for ionic conduction. As a result, catalysts are necessary in order to ensure a sufficient reaction rate of the electrochemical reaction in the fuel cell. The strongly acidic character of the membrane requires the use of precious metal catalysts such as platinum or platinum alloys for coating the membrane. As a result, high purity of the hydrogen-containing fuel gas is required. Particularly carbon monoxide (CO) is only tolerated in very low amounts since it acts as catalyst poison and thus significantly reduces the service life of the PEM fuel cell.

### SUMMARY OF THE INVENTION

Exemplary embodiments of the present invention address the problem of proposing an aircraft which has a particularly durable and reliable fuel cell system with a reformer.

In an advantageous embodiment of the invention, an aircraft has a propulsion unit with a compressor and a bleed air device for providing bleed air from the propulsion unit, a fuel tank for a fuel, at least one fuel cell, a reactor for reforming fuel from the fuel tank to a hydrogen-containing fuel gas, at least one feed unit with a bleed air inlet, a fuel inlet, an oxidizing agent outlet and a fuel outlet, wherein the feed unit is designed to selectively and not simultaneously feed an oxidizing agent into the reactor by means of the oxidizing agent outlet or feed fuel to the reactor by means of the fuel outlet, wherein the feed unit is connected to the bleed air device and designed to provide the oxidizing agent based on bleed air.

The propulsion unit with a compressor and a bleed air device can be a turbojet engine, alternatively also a turboprop engine, wherein both types of propulsion units have one or more compressor stages. According to the prior art, it is standard to draw air at a relatively high pressure from one or more compressor stages of such a propulsion unit, for example, in order to operate and simultaneously supply an air-conditioning system with air.

The fuel cell can be designed as a PEM fuel cell, which is provided with a hydrogen-containing fuel gas by a separate reactor. Alternatively, the fuel cell can also be realized as a solid oxide fuel cell (SOFC) with an upstream reactor or reformer.

In principle, an oxidizing agent or dehydrogenation can be used for reforming. The use of an oxidizing agent generates synthesis gas, while a mixture of hydrogen and dehydrated residual fuel forms during dehydrogenation. After separating the dehydrated residual fuel and the contaminates, either synthesis gas or hydrogen gas is fed to the fuel cell. Therefore, it is recommended to use a solid oxide fuel cell when using synthesis gas because the carbon monoxide contained in the gas would poison the catalyst of a polymer electrolyte fuel cell. Preferably, a polymer electrolyte fuel cell should only be used if the hydrogen-containing gas, which has left the reactor, was obtained by means of a partial dehydrogenation of the fuel.

The feed unit for feeding an oxidizing agent to the reactor is a device connected to the bleed air device and can thus receive bleed air. The oxidizing agent, which is emitted from the feed unit and fed to the reactor, removes accumulated contaminants in the form of coke or sulfur on a catalyst of the reformer through oxidation.

The removal of accumulations on catalysts of a reformer can effectively increase its service life. In order to prevent unwanted reaction with the fuel to be reformed, it stands to reason that the reformer can only be regenerated in specific temporal intervals during which the reformer is put out of operation and only a stream of the oxidizing agent is fed through it.

An advantageous embodiment further has at least one discharge unit with an inlet, a fuel gas outlet, and a waste gas outlet, wherein the discharge unit is designed to selectively and not simultaneously feed reaction products from the reactor to the fuel cell by means of the fuel gas outlet or to the surroundings of the aircraft by means of the outlet. As a result, it can be ensured that hot waste gases from a regeneration process of the reactor are particularly not applied to a polymer electrolyte fuel cell and thus do not damage said polymer electrolyte fuel cell.

In an advantageous embodiment, the bleed air device is designed to provide bleed air as oxidizing agent from a first bleed air connection of the propulsion unit with a temperature of at least 250° C. Since a propulsion unit of an aircraft can have a plurality of compressor stages, different bleed air connections can be provided from which to draw compressed air with different pressures and temperatures. In conventional turbojet engines, bleed air connections are used which provide bleed air with a temperature between 250° C. and 650° C. A low temperature, for example 250° C. or lower, also burns off coke and sulfur and even though it requires more time for such process, the integrity of the catalysts remains protected.

In an advantageous embodiment, the bleed air device is designed to provide bleed air as oxidizing agent from a second bleed air connection of the propulsion unit with a temperature of at least 450° C. This corresponds to a bleed air connection that is arranged in a higher compressor stage and thus provides air with higher pressure and higher temperature. The higher the temperature, the quicker the burning process of coke and sulfur, wherein the usability of this relatively high temperature depends on the type of reformer or catalyst used. In principle, the following catalysts or reformers are suitable: Pt- and Pd-containing catalysts for the partial dehydrogenation as well as catalytic partial oxidation, or autothermal steam reforming.

Generally, the bleed air device can also comprise bleed air lines that are connected by means of valves to a plurality of bleed air connections and provide different bleed air temperatures and pressures as needed. When necessary, different bleed air flows from different bleed air outlets can be mixed. Of course, it is also conceivable that the bleed air device has not only a single bleed air outlet but also a plurality of bleed air outlets for different intended uses. This can be particularly advantageous if suitable lines and/or valves are used for the appropriate temperatures.

In an advantageous embodiment, an ozone generator is provided that produces ozone from an incoming bleed air flow. For example, the ozone generator could be based on a dielectric barrier discharge. The application of ozone to decontaminated catalysts is advantageous because regeneration is possible at low temperatures and the mechanical properties of the catalyst are protected. This applies to PEM fuel cells and SO fuel cells in order to remove carbon or sulfur from catalyst surfaces. Ozone is much more reactive than molecular oxygen; the additional oxygen atom can be considered to be a Lewis base which very easily bonds with a Lewis acid on the catalyst. The use of Y—Al2O3 in a catalyst by way of example causes a chemical reaction of ozone with accumulated coke forming CO2:

Z—Al+O₃→Z—AlO+O₂

Z—AlO+CₓH_{y}→Z—Al+CₓH_{y}O_{z}→ . . . +Z—AlO→ . . . CO₂+H₂O+Z—Al.

In an advantageous embodiment, a bleed air cooler is arranged upstream of the bleed air inlet of the feed unit. This is particularly meaningful if bleed air is provided for an ozone generator, which cannot permanently withstand higher temperatures without damage. Moreover, no high temperature level is required for the use of ozone, and so possibly precooled bleed air from an air-conditioning unit or the like can be used for the ozone generator, and therefore the bleed air cooler is an integral component of the air-conditioning unit.

In an advantageous embodiment, the feed unit has at least one fuel valve and at least one oxidizing agent valve. The term oxidizing agent valve does not refer to the valve directly on a bleed air connection but is an interrupting device within the feed unit which applies bleed air as the oxidizing agent to a reactor or interrupts said application with bleed air. The fuel valve is provided for preventing the fuel inflow to the reactor in case of regeneration with the oxidizing agent on the basis of bleed air.

In an advantageous embodiment, one of the at least one fuel cell is a polymer electrolyte fuel cell that can be connected to a separate reactor for providing a hydrogen-containing fuel gas, wherein the polymer electrolyte fuel cell has a fuel gas inlet connected to the fuel gas outlet of the discharge unit by means of a fuel gas line. Polymer electrolyte fuel cells are usually provided with a hydrogen-containing fuel gas and oxygen, wherein an upstream reactor provides as pure as possible a hydrogen-containing gas and emits at least CO2 as waste product to the surroundings of the airplane.

In an advantageous embodiment, the fuel gas line has an air inlet for feeding air into the fuel gas line. As a result, the carbon monoxide tolerance within the fuel cell can be increased. The use of platinum for a catalyst of the reformer leads to the following reaction:

Pt+CO→CO—Pt,

Pt+O₂→O₂—Pt,

CO—Pt+O₂—Pt→CO₂+2Pt.

In an advantageous embodiment, the air inlet is connected to an air outlet of an air-conditioning unit of an air-conditioning system, where pretreated fresh air is provided that has a tolerable temperature level and can be fed very easily into the air inlet by means of appropriate pressure.

In an advantageous embodiment, an oxidizing agent inlet of the fuel cell is connected to an outlet of an ozone generator. Ozone is thus fed to the fuel cell, and so carbon monoxide is reduced or completely eliminated, thus distinctly increasing the carbon monoxide tolerance of the system.

In an advantageous embodiment, one of the at least one fuel cell is a solid oxide fuel cell executes an integrated reforming process. Applying molecular oxygen or ozone to such a fuel cell causes particularly coke and sulfur to burn off while emitting CO₂ and sulfur dioxide.

In an advantageous embodiment, a reactor in the form of a pre-reformer is arranged upstream of the solid oxide fuel cell for which the aforementioned features related to external reformers can also apply.

### BRIEF DESCRIPTION OF THE DRAWINGS

FIG. 1 shows in detail the fuel cell system of an aircraft in a first embodiment.

FIG. 2 shows a fuel cell system of an aircraft in a second embodiment.

FIGS. 3 and 4 show the fuel cell systems from FIGS. 1 and 2, limited to the exclusive use of solid oxide fuel cells.

### DETAILED DESCRIPTION

A fuel cell system 2 having a fuel cell 4, which has a PEM fuel cell or a solid oxide fuel cell, is illustrated in the figures. The fuel cell 4 has a fuel gas inlet 8 connectable to a fuel gas outlet 10 of a reactor 12. The reactor 12 is provided with fuel from a fuel inlet 14 and can generate a hydrogen-containing gas by means of a catalytic reaction. CO₂, among others, accumulates as waste product and is fed to the surroundings of the aircraft by means of a waste gas outlet 16. The reactor 12 can be designed as reformer or as pre-reformer for the use in solid oxide fuel cells.

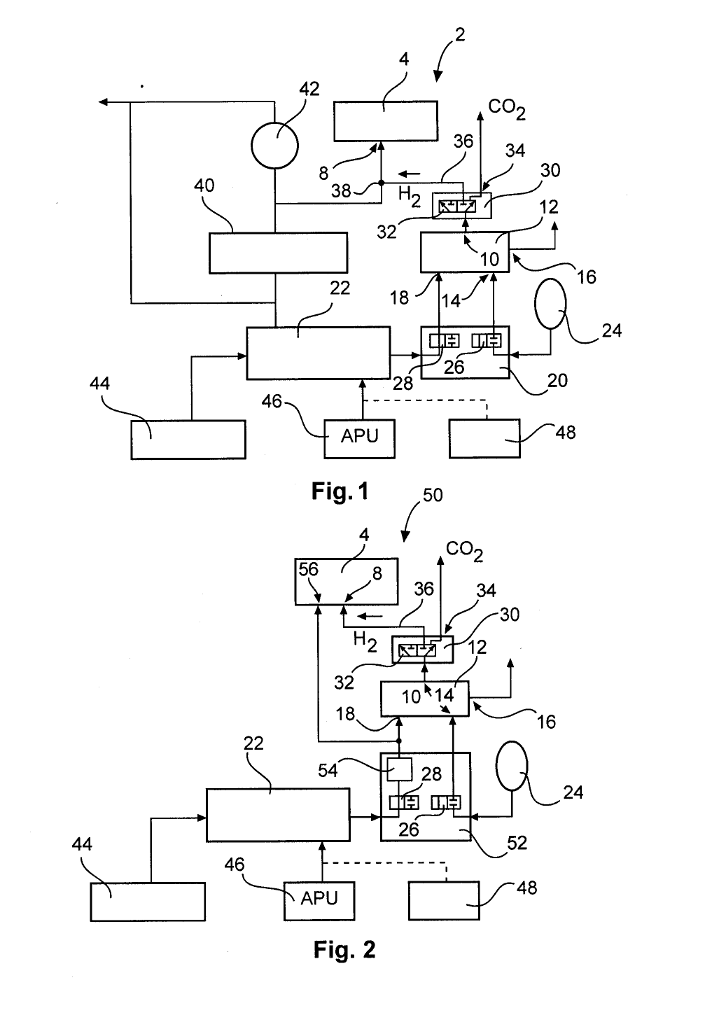

Generating a hydrogen-containing gas from a fuel, e.g. kerosene, poses the risk of catalysts in the reformer accumulating, in particular, coke that covers the surface and thus distinctly decreases the level of efficiency of the catalyst. Therefore, it is particularly helpful to regenerate the catalysts through burning off the accumulations, which requires an interruption of the operation of the reactor 12 in order to burn off the residues through the introduction of an oxidizing agent by means of an oxidizing agent inlet 18. In the embodiment depicted in FIG. 1, hot air is used as oxidizing agent that has sufficient oxygen content and a sufficient temperature in the range of approximately 450° C. to 550° C.

The hot air can be obtained from a feed unit 20 which is connected to a bleed air device 22. The feed unit 20 is further connected to a fuel reservoir 24. The feed unit 20 has a fuel valve 26 and an oxidizing agent valve 28 for selectively and not simultaneously feeding fuel or an oxidizing agent into the reformer 12. The simultaneous feeding of fuel and oxidizing agent must be prevented due to a risk of explosion.

The feed unit 20, for example, can be designed to provide an automatic regeneration of the reactor 12 at specific temporal intervals, particularly if temporarily no electrical power is required from the fuel cell 4. Alternatively, it is also conceivable to use two identical reactors 12, which are regenerated in sequence, in the fuel cell system and therefore one reactor 12 can invariably be used for providing a hydrogen-containing gas.

For protecting the fuel cell 4, particularly when designed as polymer electrolyte fuel cell, it is necessary not to introduce the containing products into the fuel cell 4 during regeneration. This is possible with a discharge unit 30 having an outlet valve 32 which selectively connects either a fuel gas inlet 8 of the fuel cell 4 or a waste gas outlet 34 to the reactor 12.

In the drawing in figure FIG. 1, the valves 26, 28, and 32 are connected such that the reactor 12 is regenerated. Fuel from the fuel reservoir 24 is blocked by the fuel valve 26. The oxidizing agent is fed into the reactor 12 by means of the oxidizing agent valve 28 where the burning process is initiated, and the products resulting from said process, primarily CO₂ and possibly SO₂, are fed to the waste gas outlet 34 by means of the outlet valve 32.

The separate depictions of the discharge unit 30 and the feed unit 20 are not intended to imply that these components must be provided absolutely separately from a reactor 12. Instead, it is conceivable and meaningful to integrate these components directly in the reactor 12, provided this is possible with the use of an external reactor.

Polymer electrolyte fuel cells have a relatively low carbon monoxide tolerance, and so the hydrogen-containing fuel gas should be as free as possible of carbon monoxide. However, proceeding from the fuel used, this is difficult to accomplish, and so in a fuel gas line 36 which, at regular operation of the reformer 12, extends from a fuel gas outlet 10 to a fuel gas inlet 8 of the fuel cell 4, an air inlet 38 is integrated, into which, for example, molecular oxygen or air is fed. This causes a chemical reaction in the fuel cell 4 which reduces the carbon monoxide content. The tolerance of the fuel cell 4 with regard to carbon monoxide led in the fuel gas line 36 can thus be significantly increased.

For introducing molecular oxygen or air into the fuel gas line 36, it appears useful to use air from an air-conditioning unit 40 before it reaches a mixer unit 42 where it is mixed with recirculated air. The air-conditioning unit 40 is capable of providing treated and suitably temperature-controlled air with sufficient pressure for introducing such air from a bleed air device 22 into the fuel gas line 36.

If the reactor 12 is not regenerated during a flight phase, bleed air from an APU 46 or from a floor connector 48, instead of an aircraft propulsion unit 44, can be used, wherein an auxiliary heating is required for the latter.

FIG. 2 shows a modified fuel cell system 50. Alternatively or additionally to the exclusive use of hot bleed air as oxidizing agent, an ozone generator 52 is used in a feed unit 50, the ozone generator being provided with bleed air at a somewhat lower temperature level and feeding ozone into the reactor 12. The effect of the burning of residues in a catalyst can be significantly increased due to the more reactive ozone.

For increasing the carbon monoxide tolerance, ozone can furthermore also be introduced into the fuel cell 4 in a separate inlet 54, and so the present or introduced carbon monoxide is converted to carbon dioxide.

If a plurality of fuel cells 4 and reactors 12 is used, it is of course also possible to multiply the number of feed units 20 and/or 52 and to multiply the number of discharge units 30, and so all fuel cells 4 can be regenerated individually. The feed units 20 and 52 can also be modified such that they can perform the function of multiple feed units and discharge units. For example, this would require a corresponding number of valves. If a plurality of fuel cells 4 and reactors 12 is used, it is further possible to provide a control unit designed to regenerate the reactors 12 in sequence and not simultaneously by means of synchronized controlling of the valves, and so the fuel cells 4 are consistently provided with electricity and other products, albeit with somewhat decreased power. Said power can be compensated briefly by means of an energy storage device, e.g., a battery, alternatively also by generators on a propulsion unit 44.

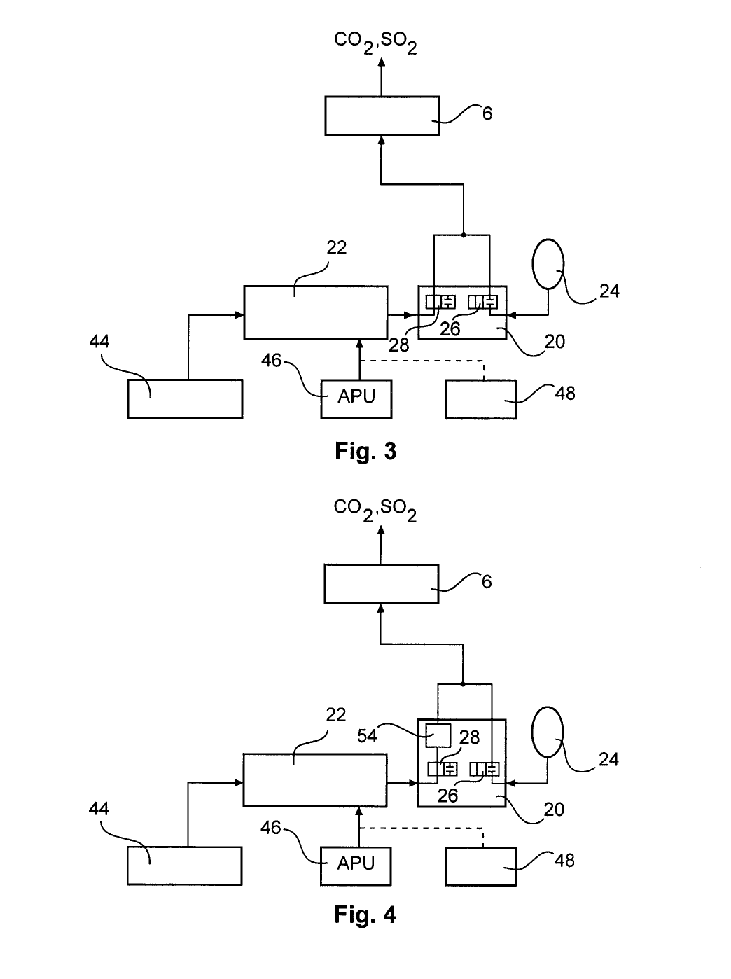

FIGS. 3 and 4 illustrate the design of the fuel cell systems 2 and 50 if the fuel cell 4 that is used is a solid oxide fuel cell 6, which exclusively executes an internal reformer process without an upstream reformer 12. Accordingly, the catalysts arranged in the solid oxide fuel cell 6 must thus be considered to be reformers or reactors and are also exposed to accumulating coke and sulfur. The design would be somewhat simplified since no discharge unit 30 is required.

The fuel and the oxidizing agent are fed into the same inlet of the fuel cell 6, connected to the oxidizing agent valve 28 and the fuel valve 26.

At the same time, due to the favorable CO tolerance of solid oxide fuel cells, it is no longer necessary or particularly advantageous to additionally introduce air into a fuel gas line, and so the part of the fuel cell system depicted in FIG. 1 can be omitted.

As a supplement, it should be noted that “comprising” does not exclude any other elements or steps, and that “a” or “an” does not exclude a plurality. It should furthermore be noted that features or steps described with reference to one of the above embodiment examples may also be used in combination with other features or steps of other embodiment examples described above.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-13. (canceled)

14. An aircraft, comprising:
a propulsion unit with a compressor and a bleed air device configured to provide bleed air from the propulsion unit;
a fuel tank configured to hold a fuel;
at least one fuel cell;
a reactor configured to reform fuel from the fuel tank to a hydrogen-containing fuel gas; and
a feed unit with a bleed air inlet, a fuel inlet, an oxidizing agent outlet, and a fuel outlet, wherein the feed unit is configured to selectively and not simultaneously feed an oxidizing agent by the oxidizing agent outlet into the reactor or fuel by the fuel outlet into the reactor,
wherein the feed unit is connected to the bleed air device and is configured to provide the oxidizing agent using the bleed air.

15. The aircraft of claim 14, further comprising:
a discharge unit with an inlet, a fuel gas outlet, and a waste gas outlet, wherein the discharge unit is configured to selectively and not simultaneously feed reaction products from the reactor to the fuel cell by the fuel gas outlet or to the surroundings of the aircraft by the waste gas outlet.

16. The aircraft of claim 14, wherein the bleed air device is configured to provide bleed air as oxidizing agent from a first bleed air connection of the propulsion unit with a temperature of at least 250° C.

17. The aircraft of claim 14, wherein the bleed air device is configured to provide bleed air as oxidizing agent from a second bleed air connection of the propulsion unit with a temperature of at least 450° C.

18. The aircraft of claim 14, wherein the feed unit has an ozone generator connected to the bleed air inlet and the oxidizing agent outlet.

19. The aircraft of claim 18, wherein a bleed air cooler configured to cool bleed air is arranged upstream of the bleed air inlet of the bleed air unit.

20. The aircraft of claim 14, wherein the feed unit has at least one fuel valve and at least one oxidizing agent valve.

21. The aircraft of claim 15, wherein one of the at least one fuel cell is a polymer electrolyte fuel cell connectable to a separate reactor for providing a hydrogen-containing fuel gas, wherein the polymer electrolyte fuel cell has a fuel gas inlet connected to the fuel gas outlet of the discharge unit by a fuel gas line.

22. The aircraft of claim 21, wherein the fuel gas line has an air inlet configured to feed air into the fuel gas line.

23. The aircraft of claim 22, wherein the fuel gas line air inlet is connected to an air outlet of an air-conditioning unit of an air-conditioning system.

24. The aircraft of claim 21, wherein an oxidizing agent inlet of the fuel cell is connectable to an outlet of an ozone generator.

25. The aircraft of claim 14, wherein one of the at least one fuel cell is a solid oxide fuel cell configured to perform an integrated reforming process.

26. The aircraft of claim 25, wherein a reactor in the form of a pre-reformer is arranged upstream of the solid oxide fuel cell.
